(19) United States
(12) Patent Application Publication
(10) Pub. No.: US 2024/0020423 A1
(43) Pub. Date: Jan. 18, 2024

(54) METHODS, SYSTEMS, ARTICLES OF MANUFACTURE AND APPARATUS TO IMPROVE CONTAINER SECURITY

(71) Applicant: Intel Corporation, Santa Clara, CA (US)

(72) Inventors: Mikko Kalevi Ylinen, Lempaala (FI); Ismo Puustinen, Helsinki (FI); Malini Bhandaru, San Jose, CA (US)

(21) Appl. No.: 18/478,481

(22) Filed: Sep. 29, 2023

(51) Int. Cl. G06F 21/64

(52) U.S. Cl. CPC G06F 21/64

(57) ABSTRACT

Systems, apparatus, articles of manufacture, and methods are disclosed to improve container security. An example apparatus includes interface circuitry to access network resources, instructions, and programmable circuitry to at least one of instantiate or execute the instructions to parse an inventory data structure to identify (a) first data structures corresponding to a container and (b) second data structures corresponding to an attestation circuit interface, and verify a combination of validation elements corresponding to the first and second data structures.

### FIELD OF THE DISCLOSURE

This disclosure relates generally to confidential computing and, more particularly, to methods, systems, articles of manufacture and apparatus to improve container security.

### BACKGROUND

In recent years, third party computing services have provided clients with increasing opportunities to perform computational services in a cloud computing environment. In some examples, clients are charged for a particular quantity of computing processor cycles consumed for different types of computing tasks.

### BRIEF DESCRIPTION OF THE DRAWINGS

FIG. 1 is a block diagram of an example environment in which example container security circuitry operates to improve container security.

FIG. 2 is a block diagram of an example implementation of the container security circuitry of FIG. 1.

FIGS. 3-5 are a flowcharts representative of example machine-readable instructions and/or example operations that may be executed, instantiated, and/or performed by example programmable circuitry to implement the container security circuitry of FIG. 2.

FIG. 6 is a block diagram of an example processing platform including programmable circuitry structured to execute, instantiate, and/or perform the example machine-readable instructions and/or perform the example operations of FIGS. 3-5 to implement the container security circuitry of FIG. 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine-readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time within 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Computing service providers, such as cloud service providers (CSPs) and/or other entities that facilitate computational resources for workload execution, have become a ubiquitous convenience for clients. The convenience of sending workloads to a CSP (e.g., Amazon Web Services®, Microsoft Azure®, Alibaba Cloud®, etc.) allows a client to focus on task execution without the management and/or capital expense of underlying hardware computing resources to execute tasks.

In some examples, clients will utilize containers to perform task execution on remote computing resources (hereinafter referred to as CSPs in the aggregate). As used herein, a container is a contained, deployable data structure of software that provides code and needed dependencies (e.g., libraries) for proper execution on underlying computational resources. While containers and/or other software packages may be securely assembled at a first time for future deployment to one or more CSPs, the integrity (e.g., integrity status) of such containers is not guaranteed during runtime (e.g., a second time). For instance, after a root filesystem is prepared for execution on CSP resources, attackers can make modifications to one or more individual files to cause unwanted and/or otherwise nefarious behaviors. In some examples, the integrity of a CSP may not be fully appreciated. Cautious deployment of workloads in circumstances and/or environments to achieve secure operating conditions where complete control is not a luxury is one of the tenants of confidential computing. In a typical environment that uses containers, the containers are stored in a container registry, which in some examples is a third party repository (e.g., a public repository) that is accessible to other clients and/or entities. When the container is thereafter deployed to a cloud (e.g., a CSP), the container image is pulled and/or otherwise retrieved, at which point the container becomes visible and/or otherwise accessible to the CSP. As a result, the CSP could modify files in the container after a point at which traditional approaches no longer implement protection measures against such activities. In other words, one or more individual files (e.g., a binary) of the container may be modified. While examples disclosed herein illustrate security improvements for containers, examples disclosed herein are not limited thereto. Generally speaking, any type of application (e.g., a container-based application, a virtual machine, etc.) may be realized by examples disclosed herein.

Efforts to combat such possibilities include modifications to the container itself to build-in unique and/or otherwise customized security mechanisms. However, such customized security modifications limit the applicability of the container, thereby limiting its adaptation as a widely-accepted tool. Further, such detailed container modification typically involves unique security and/or programming expertise that clients may not possess. Additionally, modifications to a container may cause the container to fail to meet compliance with Open Container Initiative (OCI) requirements. The OCI framework includes various requirements, including a runtime specification that defines a root file directory to identify program(s) to be executed in an isolated environment and any dependencies to be executed with the container. Examples disclosed herein permit container security improvements without any need to modify the container itself, thereby maintaining the uniform acceptability of containers among different clients.

In an effort to permit organizations and/or consumers of containers to understand their applications, an inventory data structure is generated to provide a list of software components, dependencies and metadata associated with the container. In some examples, the inventory data structure is referred to herein as a software bill of materials (SBOM), which is also referred to herein as inventory lists or inventory data structures. Further references to inventory data structures are hereinafter referred to herein as SBOMs. Stated differently, an SBOM is a data structure containing an inventory of software components (as used herein, a “component” refers to software code, code files, and/or combinations thereof) and dependencies (e.g., particular libraries that are needed for corresponding components), which is particularly helpful to organizations to appreciate the different nested components needed by container implementation. In some examples, the SBOM includes source and licensing information for each component, and the inventory provided therein enables organizations to evaluate potential risks of various components. With the information provided by SBOMs, organizations may react and/or otherwise be responsive to future attacks associated with one or more components and take preventative actions to block and/or otherwise mitigate damage caused by attacks related to particular components.

SBOMs are typically stored in container registries (e.g., third party repositories, public repositories, container registries, etc.) alongside container images with a reference link to that image. In some examples, the SBOM includes validation elements corresponding to the container and/or components within the container (e.g., individual file checksums for each container file, error redundancy codes such as cyclic redundancy checks (CRCs)). In some examples, validation elements are referred to herein as verification elements, such as checksums or other data structures that can be signed and used to verify individual portions/components of a container or interfaces (e.g., an application programming interface (API) designed and/or otherwise designated to facilitate services from particular hardware or software tools). In some examples, the SBOMs do not include file checksum information, but rather include an inventory list of the container components and dependencies. As described in further detail below, in the event the SBOM does not include a particular type of validation component (e.g., a checksum associated with a file, sometimes referred to herein as a validation element), examples disclosed herein generate one or more validation elements during the creation of the runtime verifiable manifest. Generally speaking, validation elements facilitate and/or otherwise establish a particular integrity status of a data structure at a first time, such as the time of initial creation when it is assumed that the container is built in a secure environment. Such validation elements are analyzed and/or otherwise measured at a second time after the data structure (e.g., container) is released into a public or relatively less-controlled environment. Such environments introduce a relatively greater opportunity for hackers or nefarious agents to corrupt the data structure at a second time after the first time.

Validation elements may include checksums, hashes or other numeric and/or alphanumeric data indicative of a particular container component (e.g., file). The creation of the runtime verifiable manifest is expected to occur in a controlled computing environment with particular guarantees of safety, unlike the containers that may be stored in various network locations beyond the control of the client seeking container services associated with workload execution. While SBOMs may accompany and/or otherwise be associated with containers, SBOMs may also accompany attestation circuit interfaces (ACIs). As used herein, an ACI is an interface, executable or circuit to drive, control and/or interact with trusted execution environment hardware, such as Intel Software Guard Extensions (SGX)®, RISC-V® Physical Memory Protection (PMP)®, ARM® TrustZone®, or AMD Secure Encrypted Virtualization (SEV)® interfaces. At least one ACI that interacts with Intel SGX® is referred to as Gramine®, which is a library operating system (OS) that facilitates instantiation of security capabilities (e.g., generating secure enclaves, performing attestation, etc.) provided by the attestation circuit hardware. While containers include particular hardware and software dependencies, some containers are able to take advantage of different types of attestation circuit hardware as long as a compatible ACI is invoked. As such, some ACIs include and/or are otherwise associated with an SBOM to serve as a ledger of components and/or dependencies.

Examples disclosed herein improve container security without any need to modify the container and, instead, utilize available information from corresponding SBOMs to facilitate the improved security. Examples disclosed herein generate runtime manifests based on available SBOM information to enable runtime verification in a trusted execution environment (TEE) of a destination host (e.g., a remote host, a remote host platform, a remote host computing device, a target host, a CSP, etc.), such as an enclave in which the container is to execute (e.g., an enclave instantiated by the TEE). Examples disclosed herein include a build phase and a runtime phase that is based on readily available SBOM information. During an example build phase, a workload is developed and validated before that effort is bundled into a container. During the time of container build, a development platform is expected to operate in a controlled and/or otherwise secure environment, which includes the construction, build and/or generation of a corresponding SBOM for that container. Based on the SBOM for the container and target attestation circuit hardware to be used at a host location (e.g., Intel SGX®), examples disclosed herein generate a runtime verifiable manifest. The runtime verifiable manifest is pushed to a registry for later use when a client intends to execute one or more applications or workloads with the container. At that time, the attestation circuitry validates the container to be used based on a signed combination of validation elements (e.g., checksum values corresponding to one or more files of the container and/or the attestation circuit interface).

During an example runtime phase, examples disclosed herein pull the runtime verifiable manifest from the registry and prepare the root file system on the host computing device(s) (e.g., the CSP resources). Runtime agents, such as containerd and runc, pull in data from the runtime verifiable manifest so that attestation comparisons can occur with the container and ACI being provided by the CSP. In the event that the CSP (or any other attacker that may have access to a system) has modified components of the container and/or the ACI, examples disclosed herein expose such discrepancies before rogue and/or otherwise nefarious execution can occur with a client workload (such as a client workload that was attempting to use the CSP computing resources with the target container). In some examples, a file mismatch is detected within a secure enclave operating within the CSP to signal concern for container integrity or ACI integrity (e.g., components within a Gramine instantiation have been modified).

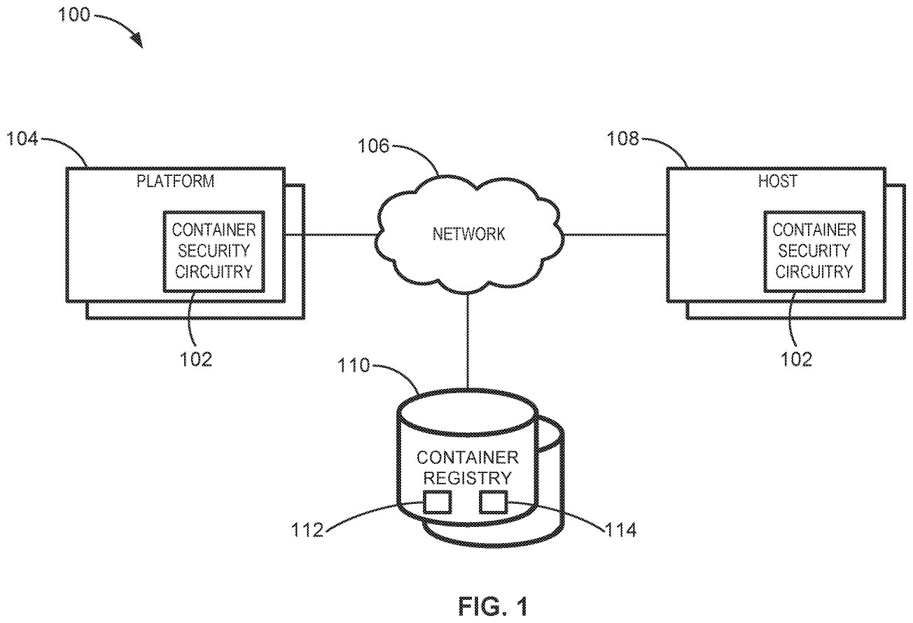

FIG. 1 is a block diagram of an example computing environment 100 in which example container security circuitry 102 operates to improve container security. In the illustrated example of FIG. 1, the computing environment 100 includes a build platform 104, such as a computing platform used by a client to generate workloads and/or containers to assist with workload execution on computing resources provided by other entities, such as cloud service providers (CSPs). As described in further detail below, the build platform 104 includes the container security circuitry 102 to build and/or otherwise generate a runtime verifiable manifest corresponding to a container. The example build platform is communicatively connected to a network 106, which is further communicatively connected to a host 108, such as computing resources available for clients to use with containers and their corresponding workloads that are to be executed in connection with the containers. In some examples, the host 108 is a CSP, such as Amazon Web Services®. The example host 108 includes container security circuitry 102. The example network 106 is also communicatively connected to a container registry 110 that, as described above, stores any number of containers 112 and/or ACIs 114 that can be retrieved by the host 108. While the illustrated example of FIG. 1 shows ACIs available and/or otherwise stored in the example container registry 110, examples disclosed herein are not limited thereto. In some examples, the host 108 may provide particular ACIs 114 that are associated with corresponding types of attestation circuitry (e.g., Intel® SGX®).

While the illustrated example of FIG. 1 includes container security circuitry 102 located in the example build platform 104 and the example host 108, runtime verifiable manifests may be generated in any location that is communicatively connected to the example network 106.

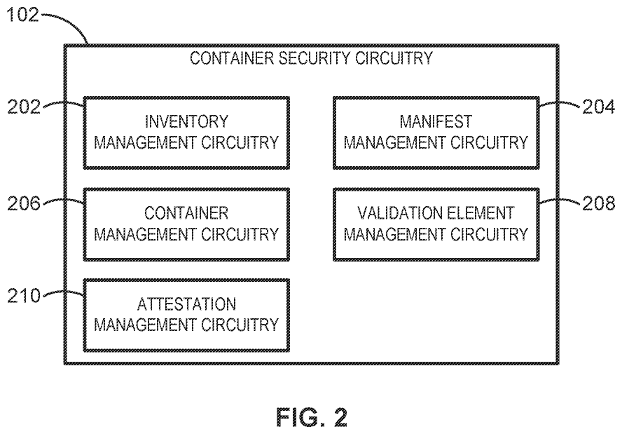

FIG. 2 is a block diagram of an example implementation of the container security circuitry 102 to provide container security improvements. The container security circuitry of FIG. 2 may be instantiated (e.g., creating an instance of, bring into being for any length of time, materialize, implement, etc.) by programmable circuitry such as a Central Processor Unit (CPU) executing first instructions. Additionally or alternatively, the container security circuitry of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

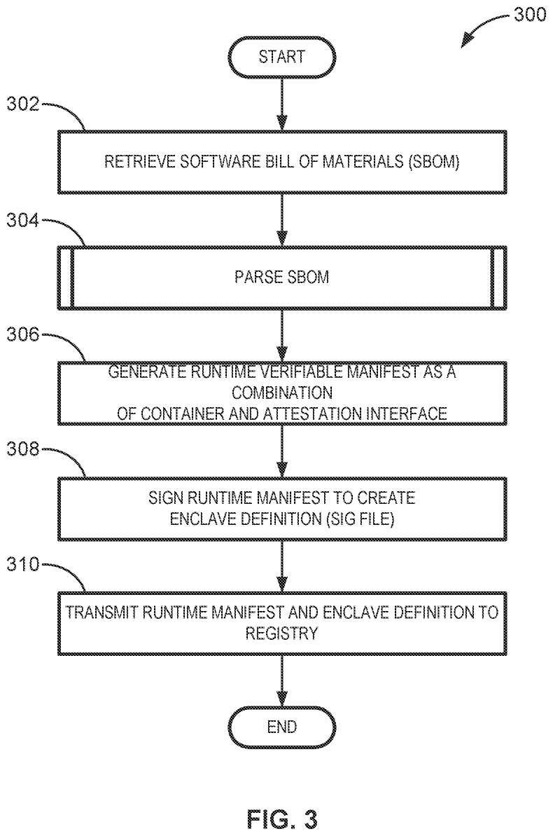

In the illustrated example of FIG. 2, the container security circuitry 102 includes example inventory management circuitry 202, example manifest management circuitry 204, example container management circuitry 206, example validation element management circuitry 208 and example attestation management circuitry 210. In some examples, the aforementioned circuitry of FIG. 2 is instantiated by programmable circuitry executing, respectively, inventory management instructions, manifest management instructions, container management instructions, validation element management instructions, and attestation management instructions and/or configured to perform operations such as those represented by the flowcharts of FIGS. 3-5.

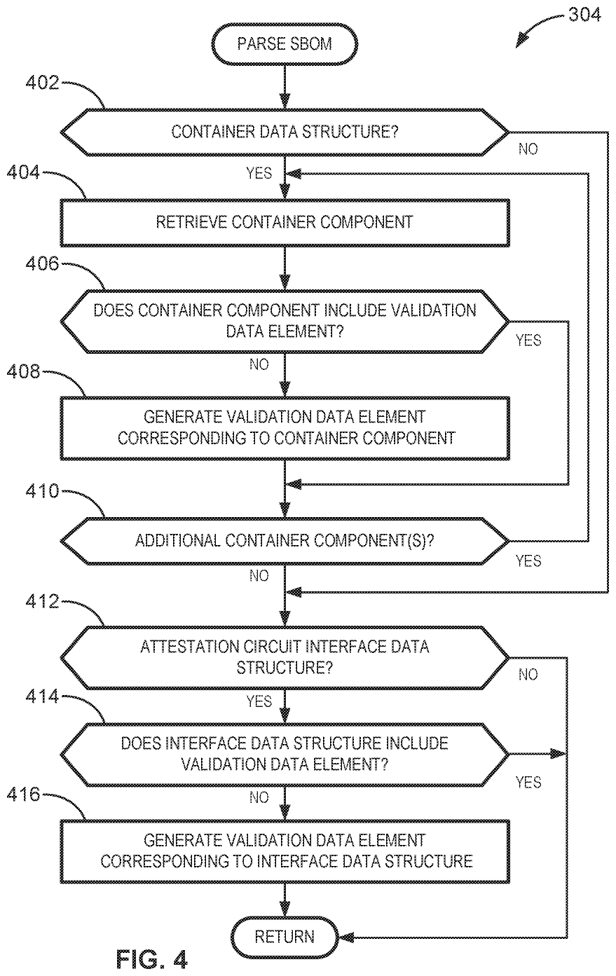

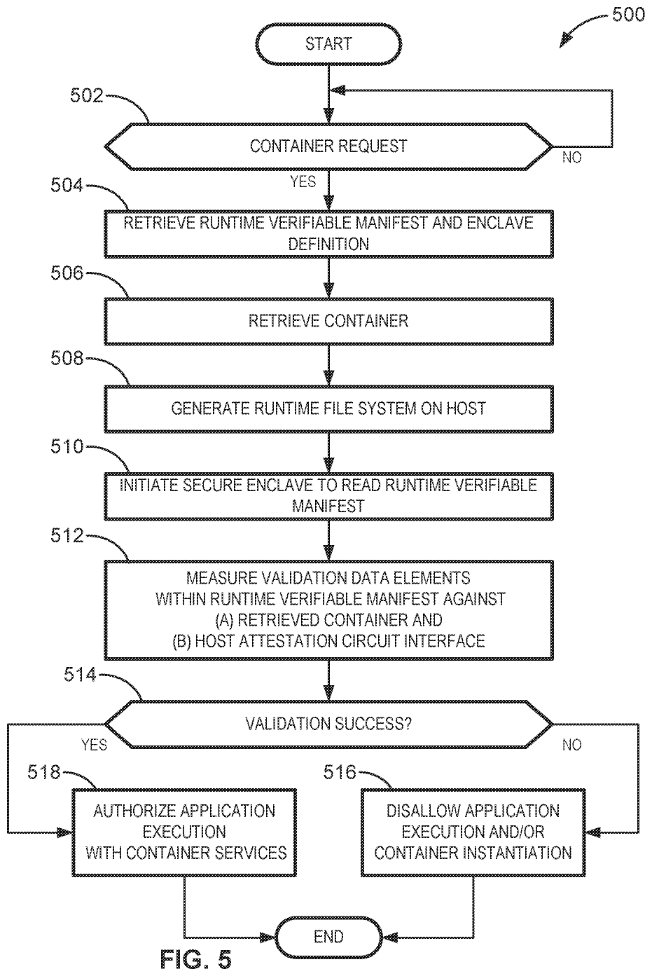

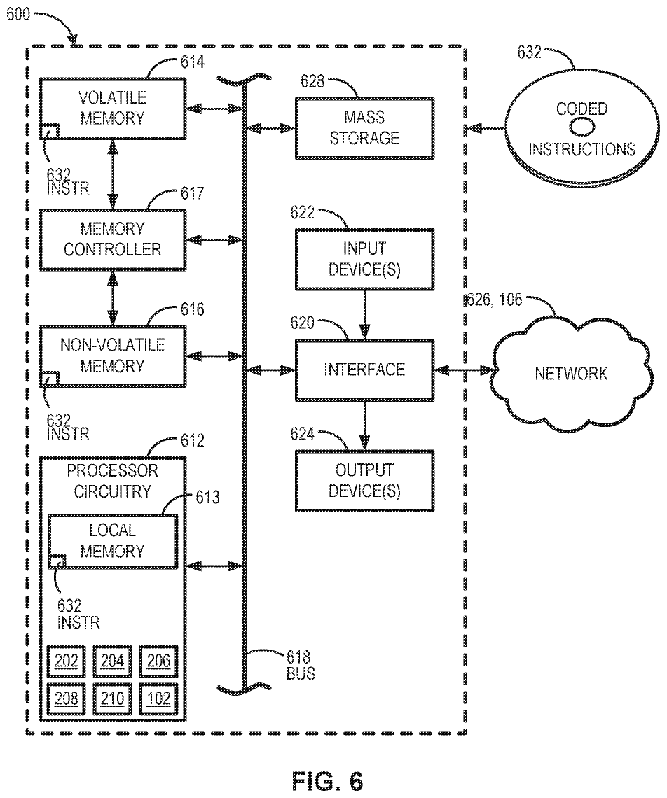

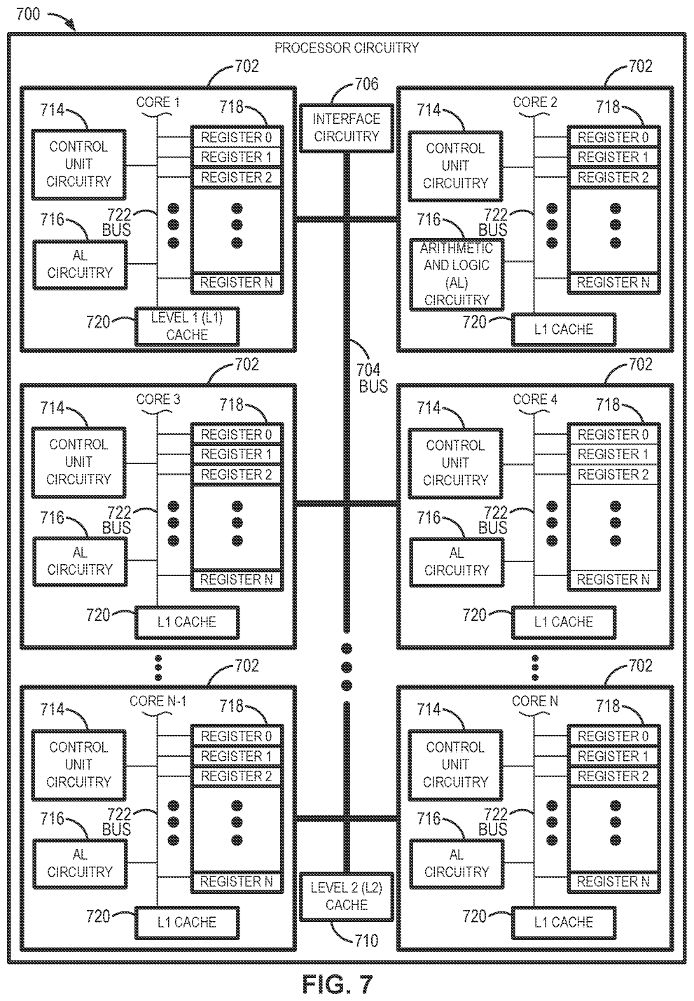

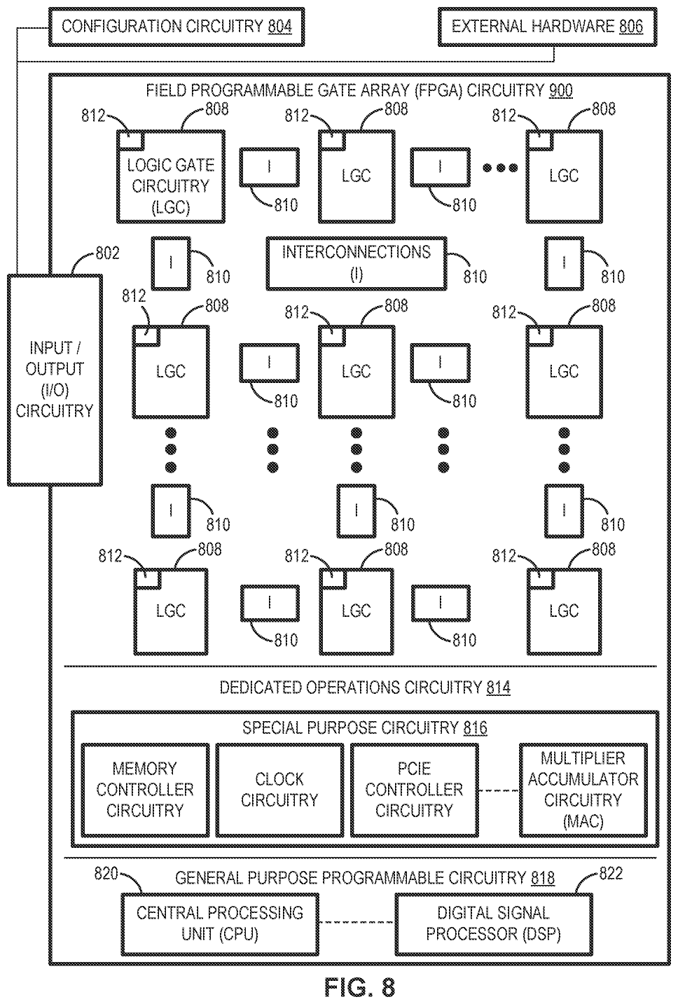

In some examples, the container security circuitry 102 includes means for inventory management, means for manifest management, means for container management, means for validation component management, and means for attestation management. For example, the means for inventory management may be implemented by inventory management circuitry 202, the means for manifest management may be implemented by manifest management circuitry 204, the means for container management may be implemented by container management circuitry 206, the means for validation element management may be implemented by validation element management circuitry 208, and the means for attestation management may be implemented by attestation management circuitry 210. In some examples, the aforementioned circuitry of FIG. 2 may be instantiated by programmable circuitry such as the example programmable circuitry 612 of FIG. 6. For instance, the aforementioned circuitry of FIG. 2 may be instantiated by the example microprocessor 700 of FIG. 7 executing machine-executable instructions such as those implemented by at least blocks 302 through 310 of FIG. 3, block 402 through 416 of FIG. 4, and blocks 502 through 518 of FIG. 5. In some examples, the aforementioned circuitry of FIG. 2 may be instantiated by hardware logic circuitry, which may be implemented by an ASIC, XPU, or the FPGA circuitry 800 of FIG. 8 configured and/or structured to perform operations corresponding to the machine-readable instructions. Additionally or alternatively, the aforementioned circuitry of FIG. 2 may be instantiated by any other combination of hardware, software, and/or firmware. For example, the aforementioned circuitry of FIG. 2 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In operation, the example inventory management circuitry 202 retrieves and/or otherwise receives an inventory data structure, such as a software bill of materials (SBOM). As described above, SBOMs may be located in one or more registries of an Edge network. Additionally, SBOMs may include information that is unique to containers or information that is unique to ACIs. For instance, the target host 108 may include attestation circuitry corresponding to a particular security device manufacturer (e.g., Intel® SGX®), but not attestation circuitry corresponding to alternate security device manufacturers. While the container may be developed in a platform-agnostic manner, particular ACIs are used with the container to facilitate secure instantiation of the containers in any host platform, such as a commercially available CSP.

The example inventory management circuitry 202 parses the retrieved, received and/or otherwise acquired SB OM to identify whether it contains container data structure information and/or attestation circuit interface (ACI) data structure information. In particular, the example container management circuitry 206 determines whether the SB OM includes a container data structure. If not, the example container management circuitry 206 determines whether the SBOM includes an attestation circuit interface (ACI) data structure, as described in further detail below. In the event the SBOM includes a container data structure, the container management circuitry 206 retrieves a container component, such as one of any number of individual files that make up the container. The example validation element management circuitry 208 determines if the particular container component also includes a corresponding validation data element, such as a checksum. If not, the validation element management circuitry 208 generates a validation data element corresponding to the container component. Otherwise, or after the validation data element is generated, the container management circuitry 206 determines whether the container currently being parsed and/or otherwise analyzed includes additional components.

In the event all components for a particular container have been parsed and/or otherwise analyzed, the attestation management circuitry 210 determines whether the retrieved SBOM (or a separate SBOM) includes an attestation circuit interface (ACI) data structure. As described above, different types of ACIs may be instantiated to perform interaction with trusted computing hardware, such as trusted execution environments (TEEs) and circuitry associated therewith (e.g., Intel® SGX®). At least one example commercially available ACI data structure is known as Gramine® that is designed to, in part, interface Intel® SGX® confidential computing hardware. In the event a client intends to utilize a preferred container on a preferred host, then a particular ACI is also instantiated that is capable of interfacing the particular type of trusted computing hardware employed by the host. The example validation element management circuitry determines whether the interface data structure includes a validation data element, such as a checksum. If not, then the validation element management circuitry 208 generates a validation data element corresponding to the ACI or a component thereof (e.g., a particular file in a suite of files that make up the ACI data structure).

The example manifest management circuitry 204 generates a runtime verifiable manifest as a combination of the container of interest and the ACI of interest. In some examples, the manifest management circuitry 204 signs the runtime verifiable manifest to create an enclave definition, sometimes referred to as a signature (.sig) file. A combination of validation elements represents an integrity status. For instance, at a first time when a container is built, the combination of validation elements (e.g., checksums) associated with individual files of the container represent a first integrity status. Some time later, such as when the container is released to the public and/or is otherwise outside the controlled environment that was initially considered safe, the validation elements of the container are measured again to look for discrepancies. The measurement occurring at the second time represents a second integrity status. In the event the first integrity status matches the second integrity status, the data structure (e.g., container) is deemed safe and/or otherwise authorized to execute on a host platform. Accordingly, examples disclosed herein permit the use of unmodified containers and/or other data structures in computing environments outside the control of the data structure creators/designers.

The example container security circuitry 102 transmits the signed runtime verifiable manifest and enclave definition to a network registry on the example network 106 for future consumption by a runtime environment. Accordingly, during a future request by a client to invoke, instantiate and/or otherwise execute a preferred container in the future that is currently stored on a publicly available container registry, the corresponding signed runtime verifiable manifest and enclave definition provides improved security assurances during runtime. Additionally, because the signed runtime verifiable manifest and enclave definition is essentially a combination of SBOMs corresponding to (a) the desired container to be executed and (b) the desired ACI that matches TEE circuitry of the host, such TEE circuitry may be invoked without concern that the host has manipulated and/or otherwise modified one or more components of the container.

During a runtime phase, as distinguished from the build phase described above, the container security circuitry 102 determines if a host has made a container request, such as a request from the example container registry 110. If so, the example container security circuitry 102 retrieves the runtime verifiable manifest and the enclave definition, and the container management circuitry 206 retrieves container to be used by the example host 108. As described above, the example container registry 110 may store copies of containers for consumption by computing devices, but clients may not have assurances that the container is safe and/or otherwise unmodified. Additionally, clients may not have assurances that the host does not unpack the container and perform further modifications to one or more components before a root file structure is created for execution on the host.

To alleviate such concerns, the container security circuitry 102 generates a runtime file system on the example host 108, which is sometimes performed by a containerd and runc agent. The example attestation management circuitry 210 initiates a secure enclave to read the runtime verifiable manifest. The attestation management circuitry 210 measures validation data elements that are within (e.g., packaged within) the runtime verifiable manifest against (a) a measurement of the container retrieved from the container registry 110 and (b) a measurement of the host ACI residing on and/or otherwise instantiated by the host 108. In the event the measurement fails to calculate and/or otherwise determine a match, the attestation management circuitry 210 disallows workload execution and/or further instantiation of the container of interest. On the other hand, in the event the measurement is successful to illustrate that the host container and host ACI match security credentials generated and/or otherwise existing during the build phase, the attestation management circuitry 210 authorizes application/workload execution with services provided by the container.

While an example manner of implementing the container security circuitry of FIG. 1 is illustrated in FIG. 2, one or more of the elements, processes, and/or devices illustrated in FIG. 2 may be combined, divided, re-arranged, omitted, eliminated, and/or implemented in any other way. Further, the example inventory management circuitry 202, the example manifest management circuitry 204, the example container management circuitry 206, the example validation element management circuitry 208, the example attestation management circuitry 210, and/or, more generally, the example container security circuitry of FIG. 2, may be implemented by hardware alone or by hardware in combination with software and/or firmware. Thus, for example, any of the example inventory management circuitry 202, the example manifest management circuitry 204, the example container management circuitry 206, the example validation element management circuitry 208, the example attestation management circuitry 210, and/or, more generally, the example container security circuitry of FIG. 2, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example container security circuitry of FIG. 2 may include one or more elements, processes, and/or devices in addition to, or instead of, those illustrated in FIG. 2, and/or may include more than one of any or all of the illustrated elements, processes and devices.

Flowchart(s) representative of example machine-readable instructions, which may be executed by programmable circuitry to implement and/or instantiate the container security circuitry of FIG. 2 and/or representative of example operations which may be performed by programmable circuitry to implement and/or instantiate the container security circuitry of FIG. 2, are shown in FIGS. 3-5. The machine-readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-5, many other methods of implementing the example container security circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Pefl, Python, JavaScript, HyperText Markup Language (HTML), Structured Query Language (SQL), Swift, etc.

As mentioned above, the example operations of FIGS. 3-5 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine-readable instructions and/or example operations 300 that may be executed, instantiated, and/or performed by programmable circuitry to improve container security. The example machine-readable instructions and/or the example operations 300 of FIG. 3 begin at block 302, at which the inventory management circuitry 202 retrieves an SBOM. The example inventory management circuitry 202 parses the retrieved SBOM (block 304), which is described in further detail in the illustrated example of FIG. 4.

FIG. 4 includes additional detail corresponding to parsing the retrieved SBOM (block 304). In the illustrated example of FIG. 4, the example container management circuitry 206 determines if the retrieved SBOM is associated with a container data structure (block 402). If not, then control advances to block 412 where the example attestation management circuitry 210 determines whether the SB OM includes an attestation circuit interface data structure, as described above and in further detail below.

Returning to block 402, if the container management circuitry 206 determines that the SBOM includes a container data structure, then it retrieves one container component (e.g., one of the container files) from that data structure (block 404). The example validation element management circuitry 208 determines if the container component includes a validation data element (block 406), such as a file checksum or other measured data element indicative of authenticity, validation and/or non-modification of the component. If the container component does not include a validation element (block 406), then the validation element management circuitry 208 generates a validation data element corresponding to the container component being analyzed (block 408). In some examples, the generation of the validation data element is a checksum, a hash and/or any type of signature element. Because a container may include any number of components, the validation element management circuitry 208 determines whether there are any additional container components to analyze (block 410). If so, control returns to block 404.

In the event the container management circuitry 206 determines that the SBOM does not include a container data structure (block 402), the example attestation management circuitry 210 determines whether the SBOM includes an attestation circuit interface data structure (block 412), such as a reference to the type of ACI (e.g., Gramine®) to be used when invoking a container of interest. If the attestation management circuitry 210 determines that there is no ACI data structure (block 412), the example process returns to block 306 of FIG. 3. On the other hand, in the event the attestation management circuitry 210 determines that there is an ACI data structure (block 412) or a reference thereto, the validation element management circuitry 208 determines whether the data structure includes a validation data element (block 414). If so, then that particular validation data element is retained for later comparison or attestation during a future runtime to verify that the ACI being used by a target host device is legitimate and/or otherwise unmodified. However, if there is no associated validation data element, then the example validation element management circuitry 208 generates a validation data element corresponding to the ACI of interest (block 416). Control then returns to block 306 of FIG. 3.

Returning to the illustrated example of FIG. 3, the example manifest management circuitry 204 generates a runtime verifiable manifest as a combination of validation elements that are associated with (a) the container to be used and (b) the ACI to be used when instantiating the container of interest (block 306). While the separate portions of the runtime verifiable manifest may include their own validation elements (e.g., checksums associated with each of the files of the container, checksums associated with the ACI), the example manifest management circuitry 204 also signs the runtime verifiable manifest as a “package” to create an enclave definition file, sometimes referred to as a signature (.sig) file (block 308). The example container security circuitry 102 transmits the runtime verifiable manifest and the enclave definition to the example registry 110 (block 310).

FIG. 5 is a flowchart representative of example machine-readable instructions and/or example operations 500 that may be executed, instantiated, and/or performed by programmable circuitry to improve container security from a runtime phase. The example machine-readable instructions and/or the example operations 500 of FIG. 5 begin at block 502, at which the container security circuitry 102 determines whether a container request or container initiation request has occurred. In some examples, the instantiation request occurs on host computing devices, such as a host CSP. In response to such a request, the example container security circuitry 102 retrieves a runtime verifiable manifest and enclave definition from the example container registry 110 (block 504). Additionally, while the runtime verifiable manifest includes a reference and/or identifier associated with the container data structure to be used and/or otherwise instantiated on the host device, the example container management circuitry 206 retrieves the actual container data structure from the container registry 110 (block 506). For instance, the container data structure of interest may have been saved on the container registry 110 at any time prior to the instantiation request.

The example container security circuitry 102 generates a runtime file system on the example host 108 (block 508), and the attestation management circuitry 210 initiates a secure enclave to read the runtime verifiable manifest (block 510). The attestation management circuitry 210 causes a measurement to occur for attestation purposes, in which validation data elements are measured from the runtime verifiable manifest against (a) the retrieved container data structure and (b) the host attestation circuit interface being used by the host (block 512). Stated differently, the attestation management circuitry validates the container based on a signed combination of checksum values. In the event the attestation management circuitry 210 determines that the secure enclave (e.g., a trusted execution environment) identifies a failure in the validation effort (block 514), then the attestation management circuitry 210 causes the workload, application execution and/or container instantiation to stop (block 516). On the other hand, in the event the attestation management circuitry 210 determines that the secure enclave identifies a success in the validation effort (block 514), then the attestation management circuitry 210 permits and/or otherwise authorizes application, workload and/or container services to execute (block 518). In some examples, after the application, workload and/or container services are authorized to execute, the example ACI provides the capability to remotely attest additional aspects of the application to ensure integrity expectations are satisfied.

FIG. 6 is a block diagram of an example programmable circuitry platform 600 structured to execute and/or instantiate the example machine-readable instructions and/or the example operations of FIGS. 3-5 to implement the container security circuitry of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), an Internet appliance, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example inventory management circuitry 202, the example manifest management circuitry 204, the example container management circuitry 206, the example validation element management circuitry 208, the example attestation management circuitry 210, and the example container security circuitry 102.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 632, which may be implemented by the machine-readable instructions of FIGS. 3-5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 3-5 to effectively instantiate the circuitry of FIG. 2 as logic circuits to perform operations corresponding to those machine-readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine-readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine-readable instructions and/or operations represented by the flowcharts of FIGS. 3-5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I²C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7.

Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine-readable instructions. However, once configured, the FPGA circuitry 800 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine-readable instructions represented by the flowchart(s) of FIGS. 3-5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 3-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-5. As such, the FPGA circuitry 800 may be configured and/or structured to effectively instantiate some or all of the operations/functions corresponding to the machine-readable instructions of the flowchart(s) of FIGS. 3-5 as dedicated logic circuits to perform the operations/functions corresponding to those software instructions in a dedicated manner analogous to an ASIC. Therefore, the FPGA circuitry 800 may perform the operations/functions corresponding to the some or all of the machine-readable instructions of FIGS. 3-5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine-readable instructions of FIGS. 3-5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine-readable instructions represented by the flowchart(s) of FIGS. 3-5 to perform first operation(s)/function(s), the FPGA circuitry 800 of FIG. 8 may be configured and/or structured to perform second operation(s)/function(s) corresponding to a second portion of the machine-readable instructions represented by the flowcharts of FIGS. 3-5, and/or an ASIC may be configured and/or structured to perform third operation(s)/function(s) corresponding to a third portion of the machine-readable instructions represented by the flowcharts of FIGS. 3-5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine-readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

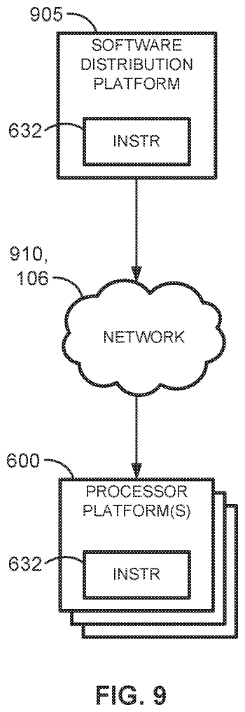

A block diagram illustrating an example software distribution platform 905 to distribute software such as the example machine-readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine-readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine-readable instructions 632, which may correspond to the example machine-readable instructions of FIGS. 3-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 632 from the software distribution platform 905. For example, the software, which may correspond to the example machine-readable instructions of FIGS. 3-5, may be downloaded to the example programmable circuitry platform 600, which is to execute the machine-readable instructions 632 to implement the container security circuitry. In some examples, one or more servers of the software distribution platform 905 periodically offer, transmit, and/or force updates to the software (e.g., the example machine-readable instructions 632 of FIG. 6) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that improve container security. In some examples disclosed herein, containers may be distributed in a generic and/or otherwise unmodified/non-modified manner for use by a wide variety of clients, unlike traditional container implementations that required modifications beyond the technical capabilities of some clients. Rather than require a client to customize and/or modify a container for a particular use case or particular security circuitry (e.g., Intel® SGX®) available to a target host, examples disclosed herein develop security assurances for the container based on inventory data structures, such as SBOMs. Examples disclosed herein employ the SBOMs together with container data structures to generate a runtime verifiable manifest that includes validation data elements that can be verified and/or otherwise attested by the host at runtime scenarios where typical container applications do not provide runtime guarantees of safety/security. Disclosed systems, apparatus, articles of manufacture, and methods improve the efficiency of using a computing device by preventing, blocking and/or otherwise restricting rogue and/or unsafe container execution and/or workload execution instances that depend on container services. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to improve container security are disclosed herein. Further examples and combinations thereof include the following:

Example 1 includes an apparatus comprising interface circuitry to access network resources, instructions, and programmable circuitry to at least one of instantiate or execute the instructions to parse an inventory data structure to identify (a) first data structures corresponding to an application and (b) second data structures corresponding to an attestation circuit interface, and verify a combination of validation elements corresponding to the first and second data structures.

Example 2 includes the apparatus as defined in example 1, wherein the programmable circuitry is to cause storage of the verified combination of validation elements in a registry associated with the application.

Example 3 includes the apparatus as defined in example 1, wherein the programmable circuitry is to cause attestation circuitry to validate the application based on a signed combination of the validation elements.

Example 4 includes the apparatus as defined in example 3, wherein the attestation circuitry is to execute on a remote host.

Example 5 includes the apparatus as defined in example 1, wherein the programmable circuitry is to cause the application to execute on a remote host in response to validation of the verified combination of validation elements.

Example 6 includes the apparatus as defined in example 1, wherein the programmable circuitry is to cause a trusted execution environment in a remote host computing device to execute the application.

Example 7 includes the apparatus as defined in example 6, wherein the trusted execution environment is an enclave.

Example 8 includes the apparatus as defined in example 6, wherein the programmable circuitry is to cause the attestation circuit interface to validate a signed combination of checksum values in a secure enclave.

Example 9 includes the apparatus as defined in example 1, wherein the inventory data structure is a software bill of materials (SBOM).

Example 10 includes the apparatus as defined in example 1, wherein the validation elements include at least one of checksum values or cyclic redundancy check (CRC) values.

Example 11 includes the apparatus as defined in example 10, wherein the programmable circuitry is to verify the combination of validation elements by signing the checksum values.

Example 12 includes the apparatus as defined in example 1, wherein the application includes at least one of a container or a virtual machine.

Example 13 includes an apparatus comprising interface circuitry to access network resources, instructions, and programmable circuitry to at least one of instantiate or execute the instructions to receive a request to instantiate a container built at a first time, the container associated with a first integrity status, verify a second integrity status of the container at a second time, the container associated with a host, and cause the container to execute a workload on the host in response to the first integrity status matching the second integrity status.

Example 14 includes the apparatus as defined in example 13, wherein the integrity status is based on a plurality of validation elements corresponding to components of the container.

Example 15 includes the apparatus as defined in example 13, wherein the container associated with the host is retrieved from a network repository.

Example 16 includes the apparatus as defined in example 15, wherein the network repository is publicly available.

Example 17 includes the apparatus as defined in example 13, wherein the programmable circuitry is to verify the container is unmodified when the first integrity status matches the second integrity status.

Example 18 includes a non-transitory storage medium comprising instructions to cause programmable circuitry to at least parse a container inventory data structure to identify first data structures corresponding to a container, parse an attestation circuit interface data structure to identify second data structures corresponding to an attestation circuit interface, and measure a combination of validation elements corresponding to the first and second data structures.

Example 19 includes the non-transitory storage medium as defined in example 18, wherein the programmable circuitry is to store the measured combination of validation elements in a registry accessible by a host, the host to execute the container.

Example 20 includes the non-transitory storage medium as defined in example 18, wherein the programmable circuitry is to measure the container based on a signed combination of the validation elements.

Example 21 includes the non-transitory storage medium as defined in example 20, wherein the programmable circuitry is to cause a host to measure the container in a secure enclave.

Example 22 includes the non-transitory storage medium as defined in example 18, wherein the programmable circuitry is to cause the container to execute on a remote host in response to measurement of the validation elements.

Example 23 includes the non-transitory storage medium as defined in example 22, wherein the programmable circuitry is to cause the container to execute in a secure enclave of the remote host.

Example 24 includes the non-transitory storage medium as defined in example 18, wherein the container inventory data structure and the attestation circuit interface inventory data structure are separate software bills of material (SBOM).

Example 25 includes the non-transitory storage medium as defined in example 18, wherein the programmable circuitry is to measure the combination of validation elements as checksum values.

Example 26 includes an apparatus comprising container management circuitry to parse an inventory data structure to identify first data structures corresponding to a container, attestation management circuitry to parse the inventory data structure to identify second data structures corresponding to an attestation circuit interface, and manifest management circuitry to verify a combination of validation elements corresponding to the first and second data structures.

Example 27 includes the apparatus as defined in example 26, further including container security circuitry to store the verified combination of validation elements in a registry associated with the container.

Example 28 includes the apparatus as defined in example 26, wherein the attestation management circuitry is to validate the container based on a signed combination of the validation elements.

Example 29 includes the apparatus as defined in example 26, wherein the attestation management circuitry is to instantiate a trusted execution environment on a remote host computing device, the container to execute in the trusted execution environment.

Example 30 includes the apparatus as defined in example 29, wherein the trusted execution environment is an enclave.

Example 31 includes the apparatus as defined in example 26, wherein the inventory data structures are software bills of material.

Example 32 includes the apparatus as defined in example 26, wherein the validation elements include checksum values.

Example 33 includes an apparatus comprising means for container management to parse an inventory data structure to identify first data structures corresponding to a container, means for attestation management to parse the inventory data structure to identify second data structures corresponding to an attestation circuit interface, and means for manifest management to verify a combination of validation elements corresponding to the first and second data structures.

Example 34 includes the apparatus as defined in example 33, further including means for container security to store the verified combination of validation elements in a registry associated with the container.

Example 35 includes the apparatus as defined in example 33, wherein the means for attestation management is to validate the container based on a signed combination of the validation elements.

Example 36 includes the apparatus as defined in example 33, wherein the means for attestation management is to instantiate a trusted execution environment on a remote host computing device, the container to execute in the trusted execution environment.

Example 37 includes the apparatus as defined in example 36, wherein the trusted execution environment is an enclave.

Example 38 includes the apparatus as defined in example 33, wherein the inventory data structure is a software bill of materials (SBOM).

Example 39 includes the apparatus as defined in example 33, wherein the validation elements include checksum values. The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry to access network resources;
instructions; and
programmable circuitry to at least one of instantiate or execute the instructions to:
parse an inventory data structure to identify (a) first data structures corresponding to an application and (b) second data structures corresponding to an attestation circuit interface; and
verify a combination of validation elements corresponding to the first and second data structures.

2. The apparatus as defined in claim 1, wherein the programmable circuitry is to cause storage of the verified combination of validation elements in a registry associated with the application.

3. The apparatus as defined in claim 1, wherein the programmable circuitry is to cause attestation circuitry to validate the application based on a signed combination of the validation elements.

4. The apparatus as defined in claim 3, wherein the attestation circuitry is to execute on a remote host.

5. The apparatus as defined in claim 1, wherein the programmable circuitry is to cause the application to execute on a remote host in response to validation of the verified combination of validation elements.

6. The apparatus as defined in claim 1, wherein the programmable circuitry is to cause a trusted execution environment in a remote host computing device to execute the application.

7. (canceled)

8. The apparatus as defined in claim 6, wherein the programmable circuitry is to cause the attestation circuit interface to validate a signed combination of checksum values in a secure enclave.

9. The apparatus as defined in claim 1, wherein the inventory data structure is a software bill of materials (SBOM).

10. The apparatus as defined in claim 1, wherein the validation elements include at least one of checksum values or cyclic redundancy check (CRC) values.

11. The apparatus as defined in claim 10, wherein the programmable circuitry is to verify the combination of validation elements by signing the checksum values.

12-17. (canceled)

18. A non-transitory storage medium comprising instructions to cause programmable circuitry to at least:
parse a container inventory data structure to identify first data structures corresponding to a container;
parse an attestation circuit interface data structure to identify second data structures corresponding to an attestation circuit interface; and
measure a combination of validation elements corresponding to the first and second data structures.

19. (canceled)

20. The non-transitory storage medium as defined in claim 18, wherein the programmable circuitry is to measure the container based on a signed combination of the validation elements.

21. (canceled)

22. The non-transitory storage medium as defined in claim 18, wherein the programmable circuitry is to cause the container to execute on a remote host in response to measurement of the validation elements.

23. The non-transitory storage medium as defined in claim 22, wherein the programmable circuitry is to cause the container to execute in a secure enclave of the remote host.

24. The non-transitory storage medium as defined in claim 18, wherein the container inventory data structure and the attestation circuit interface inventory data structure are separate software bills of material (SBOM).

25. (canceled)

26. An apparatus comprising:
container management circuitry to parse an inventory data structure to identify first data structures corresponding to a container;
attestation management circuitry to parse the inventory data structure to identify second data structures corresponding to an attestation circuit interface; and
manifest management circuitry to verify a combination of validation elements corresponding to the first and second data structures.

27. The apparatus as defined in claim 26, further including container security circuitry to store the verified combination of validation elements in a registry associated with the container.

28. (canceled)

29. The apparatus as defined in claim 26, wherein the attestation management circuitry is to instantiate a trusted execution environment on a remote host computing device, the container to execute in the trusted execution environment.

30. (canceled)

31. The apparatus as defined in claim 26, wherein the inventory data structures are software bills of material.

32. The apparatus as defined in claim 26, wherein the validation elements include checksum values.

33-39. (canceled)
